(19) United States
(12) Patent Application Publication
(10) Pub. No.: US 2008/0126954 A1
(43) Pub. Date: May 29, 2008

(54) METHOD AND SYSTEM FOR OPTIMUM PLACEMENT OF A THREAD IN AN ONLINE FORUM

(75) Inventor: Franklin Schmidt, San Francisco, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: NABBLE, INC., SAN FRANCISCO, CA (US)

(21) Appl. No.: 11/537,153

(22) Filed: Sep. 29, 2006

(51) Int. Cl. G06F 3/00

(52) U.S. Cl. 715/758

(57) ABSTRACT

The present disclosure allows a user to influence the position of a thread in an Internet forum in exchange for payment. The user can sponsor a particular thread by paying the forum provider to position the thread in a favorable position within the list of threads on the forum. For example, if threads are typically listed on the forum in reverse chronological order with respect to the latest posting within a thread, a sponsored thread might be bumped to the top of the list regardless of the time since the latest posting in the thread. In other words, by sponsoring a thread, a user pays the forum provider to offset the timeliness (or lack thereof) of the thread, or whatever factors determine the natural order of the list.

### BACKGROUND

1. Field of the Invention

The invention relates to online forums, and more particularly to methods of optimizing the placement of threads in a forum in exchange for payment.

2. Description of the Related Art

Online forums have become increasingly popular. Such forums unite a virtual community of users who share a common interest in topics such as politics, sports, hobbies, technology, or current events, to name a few. Many users consider online forums to be an important source of information concerning issues they are interested in or products they are considering purchasing. As such, online forums are of interest to individuals, groups, or companies with ideas or products to promote. The positive “buzz” created in an online forum about a product or idea can be effective advertising for the product or idea. Likewise, negative response to the product or idea can sway potential consumers away from the product or idea. A promoter of a product or idea thus has incentive to capitalize on the word-of-mouth potential of online forums and discussion groups.

Presently, online forums are underutilized as an advertising medium. Advertising in forums are limited to banner ads or contextual ads. There is presently no available systematic way of using a native thread as an advertising medium.

Though a promoter of a product or idea would likely be willing to pay for the opportunity to influence the discussion of their product or idea in an online forum, there is presently no way to control forum dynamics. Though a promoter would desire that positive opinions and discussion regarding their idea/product remain on the forum as long as possible and that negative opinions and discussion disappear as soon as possible, there is presently no satisfactory way to achieve this. As explained below, the placement of a thread within the forum is presently generally controlled by the posting activity within the thread and thus a promoter is at the mercy of the dynamics of the forum to determine the placement of posts regarding their product or idea, absent frequent posting activity by the promoter, which could be both time consuming and viewed negatively.

Methods and systems are described in the art for influencing the placement of webpages in Internet searching results and placement of advertisements on webpages. Examples include U.S. Pat. Nos. 6,907,566; 6,269,361; and 6,826,572. There is however a need in the art for allowing a user to influence the placement of thread in an Internet forum.

### SUMMARY

The methods and systems allow a user to influence the likelihood that a particular thread in an online forum will be accessed in exchange for payment. The user can “sponsor” a particular thread by paying the forum provider to favorably position the thread within the list of threads on the forum or to otherwise increase the visibility of the thread by highlighting, bolding, etc. For example, if threads are typically listed on the forum in reverse chronological order with respect to the latest post within a thread, a sponsored thread might be bumped to the top of the list regardless of the time since the latest post in the sponsored thread. In other words, by sponsoring a thread, a user pays the forum provider to offset the timeliness (or lack thereof) of the sponsored thread.

A number of financial arrangements can be utilized for sponsoring a thread. For example, a user can arrange to have a thread remain in a top position for a given amount of time or until the thread has been accessed a given number of times. Alternatively, a user can arrange for a one-time bump to a top position or for multiple bumps to the top. Payment can depend on how many spaces in the list a thread gets bumped. Alternatively, users can competitively bid against each other for favorable placement of threads in the forum. These and other arrangements are described in more detail herein. The presently disclosed methods and systems allow advertisers to use threads as a reliable advertising medium. Particularly, advertisers can utilize native, organically originating threads, which provide a more powerful advertisement medium than directed, one directional advertisements, for reasons that will be apparent in view of the below discussion.

### BRIEF DESCRIPTION OF THE DRAWINGS

FIG. 1 illustrates a system for hosting a forum on the Internet.

FIG. 2A illustrates a list of threads on a display.

FIG. 2B illustrates the hierarchical structure of a hypothetical thread.

FIG. 3 illustrates an embodiment of preferred placement of a sponsored thread.

FIG. 4 illustrates a user interface (UI) including interface elements allowing a user to sponsor a thread.

### DETAILED DESCRIPTION

The terms forum, discussion group, Internet discussion group, online discussion group, Internet forum, and online forum are used interchangeably herein.

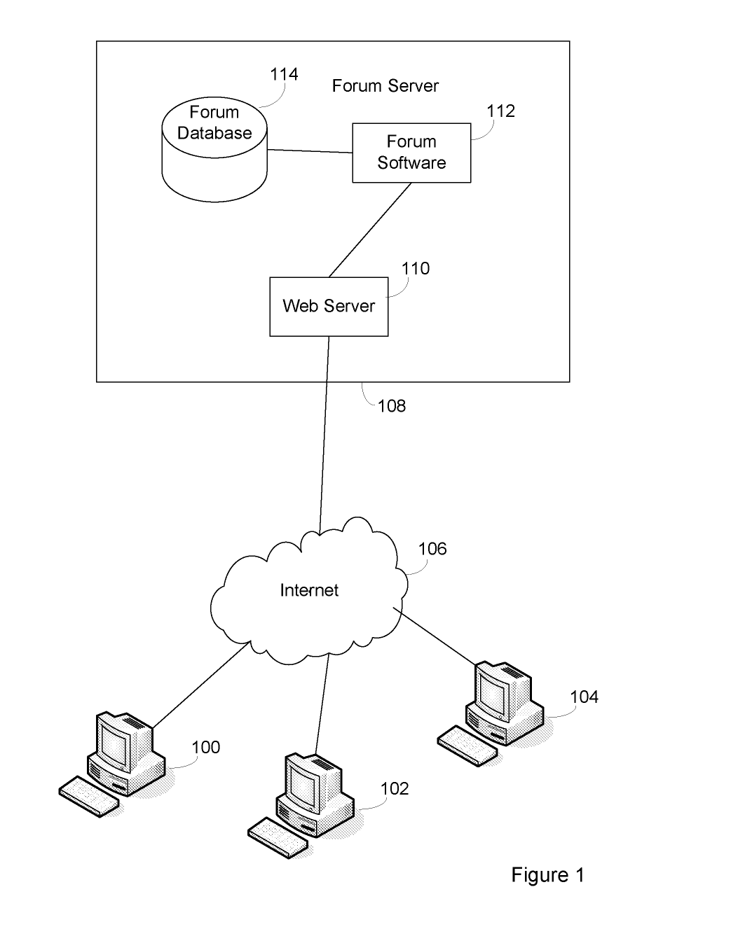

FIG. 1 illustrates a system for hosting a forum on the Internet. A series of user workstations 100, 102, and 104 are connected to the Internet 106. A forum server 108 is also connected to the Internet. The forum server 108 contains a web server 110 to interface with the Internet and to provide web pages for viewing and receiving responses with the various users. Forum software 112 is connected to the web server 110 and controls the actual development, presentation, features and capabilities of the particular forum. A forum database 114 is connected to the forum software 112 to contain the various posts and user information as required to operate the forum. The database 114 can be a conventional database such as MySQL or SQLServer and the web server 110 can be a conventional web server such as Apache or IIS.

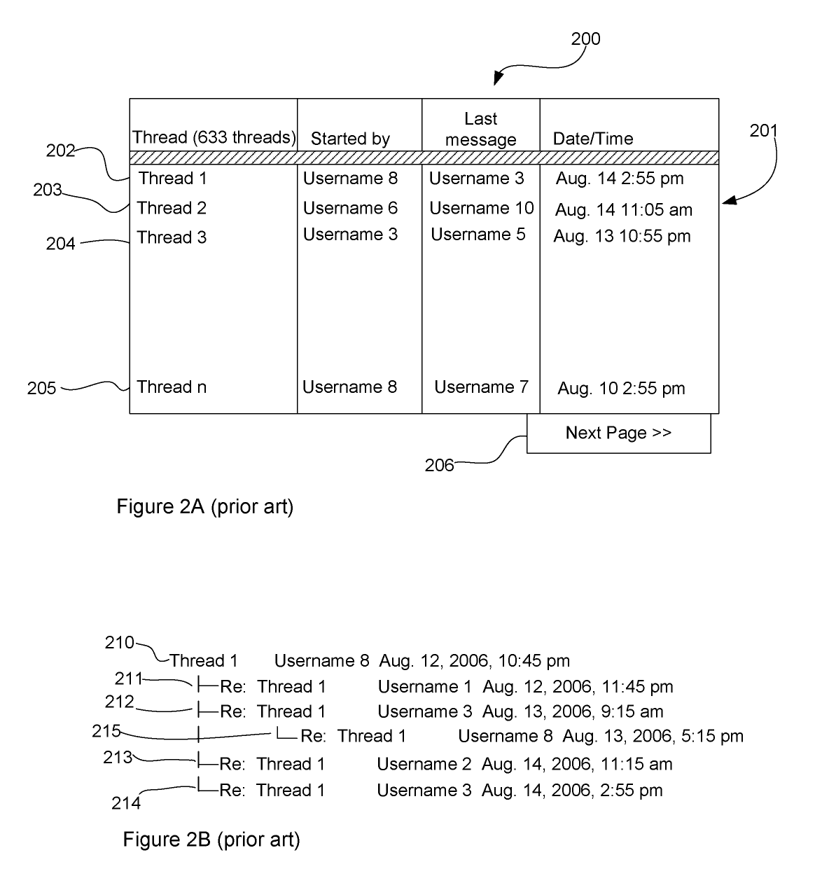

FIG. 2A illustrates a display 200 of a hypothetical forum. The display includes field 201 in which threads 202-205 are displayed, typically as hypertext. When a user clicks on one of 202-205, the hierarchical structure of the thread (illustrated in FIG. 2B) is displayed. Because the number of threads may be greater than can be displayed on a single page, the threads may spill onto following pages or downward on the display. A user can navigate to the next page using control 206.

Each thread is arranged according to hierarchical structure as illustrated in FIG. 2B. Original message 210 in hypothetical Thread 1 was created by Username 8 at 10:45 pm on Aug. 12, 2006. Each of messages 211-214 are replies to message 210, i.e., they are “children” of original message 210. Message 215 is a reply to message 212 and is a grandchild of message 210.

The threads in a forum are typically displayed in reverse chronological order, i.e., the thread containing the latest posted message is displayed at the top of the list of threads. Referring again to FIGS. 2A and 2B, the latest posted message in the forum is message 214, posted at 2:55 am on Aug. 14, 2006. Message 214 is contained in Thread 1 (202) and thus Thread 1 (202) appears at the top of the list of threads. If a message is subsequently posted in a different thread, for example in Thread 3 (204), Thread 3 (204) moves to the top of the list of threads and Threads 1 (202) and 2 (203) are bumped down in the list. When a new thread is created, the new thread appears at the top of the list and the older threads are bumped down. A period of inactivity in a given thread results in that thread being bumped down the list and eventually off of the first page. In some cases threads can be made “sticky” by the forum administrator so that the thread always appears at the top of the thread list. However, this is reserved for globally important threads due to the administrative activity required and loss of otherwise active and dynamic threads on the first page. Sponsored threads, as described herein, are not to be confused with “sticky” threads. Threads in forums can also be arranged in reverse chronological order with respect to the first posting within the thread, as opposed to the latest posting.

An interested user would desire that a thread containing positive discussion concerning their product or idea remain toward the top of the list, preferably on the first page. However, a thread's position in the list may depend on the posting activity in that thread or other factors beyond the user's control. Typically, when a thread is created there may be flurry of activity in the thread which subsides and is followed by inactivity. This flurry of activity may last a short time; a couple of days for example. The thread thus remains toward the top of the list for a short time but is quickly bumped down the list and off the first page.

The present disclosure provides a method by which a user can arrange with the forum provider to maintain a given thread at a given position within a list of threads, regardless of the posting activity within the thread or other threads in the list. For example, a user (any interested party) can pay the forum provider to maintain a particular thread on the first page of the list of threads, i.e., to prevent the thread from being bumped. A user can likewise pay the forum provider to bump a thread from a lower position in the list up to a top position, preferably on the first page.

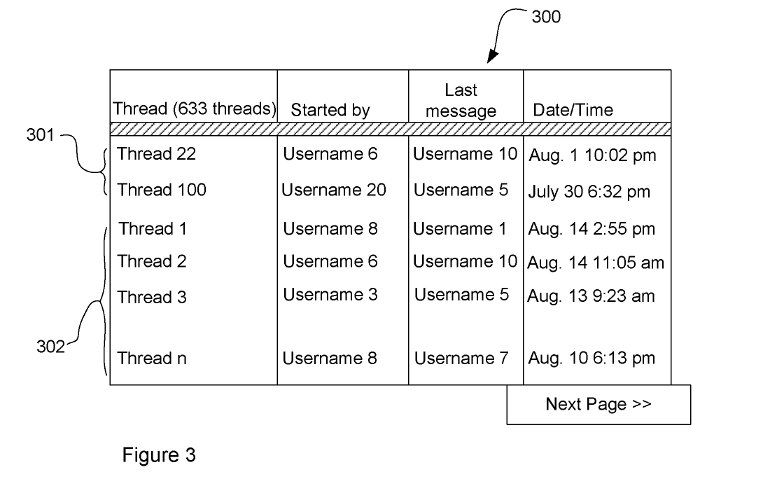

FIG. 3 illustrates one embodiment of preferred placement of a thread, as disclosed herein. The display 300 is similar to the display illustrated in FIG. 2A except that display 300 contains two groups 301 and 302 instead of a single group. Group 301 contains sponsored threads; group 302 contains un-sponsored threads. Group 302 functions similarly to group 201 in FIG. 2A; i.e., threads are displayed in reverse chronological order with respect to posting activity within the threads. However, the sponsored threads in group 301 do not move down the list in reverse chronological order, rather, they remain at the top of the list of threads regardless of the posting activity in the thread within the limits of the particular rules being applied based on the payment structure. A user can pay the forum provider to “promote” a given thread from group 302 to group 301, thus assuring that the thread remains on the first page. The term “top of the list” may refer to a range of spots at the top of the list and does not necessarily refer only to the one top thread of the list. The range can include any number of spots, as determined by the forum provider.

According to one embodiment, sponsored threads simply appear as the top threads in the list of threads. Alternatively, the display can be divided into two fields—a field for sponsored threads and a field for non-sponsored threads. The field for sponsored threads can be located at the top of the first page only of display 300. Alternatively, the field for sponsored threads can appear at the top of every page so that sponsored threads are visible on every page of the display. So while generally the threads may be listed in reversed chronological order, as depicted in FIG. 2A, sponsored threads can be automatically bumped to the top of the list regardless of the posting activity within the thread.

A variety of monetary arrangements can be utilized to allow a user to “sponsor” a thread. For example, a user might pay to sponsor a thread for a specific amount of time, for example, for a week, a month, etc. A monetary fee might allow a thread to remain in a top spot until someone else buys the top spot, but might, for example, guarantee some minimum time at the top. Alternatively, the thread can be sponsored until it shows up in the sponsored position a given number of times, i.e., a pay for impressions arrangement. The thread can be sponsored for a given price in exchange for a given number of times the thread is accessed, i.e., a pay-per-click arrangement. Still alternatively, a posting in a thread can contain a hypertext link or a banner ad, for example and the user can arrange with the forum provider to sponsor the thread for until the hypertext link or banner ad has been clicked a given number of times or can arrange to pay a certain amount of money for each time the link or banner is clicked, i.e., a pay-for-click arrangement with regard to the embedded hypertext link or banner ad. Still further, a pay-per-action transaction can be arranged, wherein the forum provider receives payment for the number of time a user interacts with either the thread, for example by posting within the thread, or for the number of times a user interacts with a hypertext link or banner ad within the thread, for example, by clicking the link or filling out information, etc. The user might create the thread himself or might post such a message in a pre-existing thread or may simply be satisfied with a pre-existing thread without specifically posting or otherwise directly or overtly drawing attention to himself. Alternatively, the hypertext might be created by someone other than the user.

A user might not be willing to pay to sponsor a desirable thread while the thread remains toward the top of the list due to the activity of posting within the thread itself. However, as the activity within the thread decreases and the thread progresses in its journey down the list, a user might pay to bump the thread back to the top of the list, either in hopes of recapturing the buzz originally generated by the thread or simply to keep the thread in the consciousness of the forum community. A user can pre-arrange to sponsor a thread once the thread falls below a certain level. The user can arrange for a one time bump up the list or can arrange for multiple bumps. A forum provider might structure his fees for bumping a thread according to the number of spaces the thread will be bumped, i.e., charging a higher price to bump a thread a greater number of spaces.

A forum provider might only make a small number of spaces available for sponsored links and thus might prefer a bidding arrangement for allocating the top spaces in a forum. In other words, multiple users, each desiring to sponsor threads, can bid against each other for the right to have their desired thread appear as the top thread in the forum. Any of the payment arrangements described herein can be conducted using a bidding system rather than a fee-based system. The winning bidder might occupy a favorable spot until another user outbids him, or the winning bidder might be win the right to occupy the favorable spot for a given amount of time, for a given number of exposures, etc. According to one embodiment, periodic bidding cycles are conducted for favorable spots, for example on a weekly basis, etc.

The present disclosure provides a method of ordering (and reordering) a list of threads in an online discussion group. Generally the threads are listed in reverse chronological order with respect to the latest posting within the threads. According to an embodiment of the method, the forum provider (or more specifically, the system providing the forum) receives a posting in a thread (referred to herein as the updated thread) and is thereby prompted to reorder the list of threads. The system determines if the thread at the top of the list, which has an earlier posting time than the updated thread, is to remain at the top of the list because of a monetary arrangement. In other words, the system determines if the thread at the top of the list is a sponsored thread. If the thread at the top of the list is not a sponsored thread, the updated thread is moved to the top of the list. If the thread at the top of the list is a sponsored thread, the system determines if the thread second from the top is a sponsored thread, and so on, such that the updated thread is moved to the first available spot below the lowest sponsored thread. For the purposes of this discussion, threads made “sticky” by the forum administrator are ignored, i.e., “top” does not include “sticky” threads. As mentioned above, sponsored threads are not to be confused with sticky threads. Sponsored threads are sponsored by a user in exchange for a monetary arrangement with the forum provider. A user can sponsor a thread because the user has a personal interest in obtaining favorable placement of the thread. In certain scenarios the updated thread may be moved ahead of sponsored threads, for example if the arrangement for the sponsored thread is to remain within a given number of threads from the top or if the fee arrangement has expired.

The description thus far has been concerned with methods allowing a user and a forum provider to arrange to move a thread up on a list of threads. It is recognized, however, that a user might also be interested in moving threads that are unfavorable to the user's interests down a list of threads and particularly off of the first page of a display or even to the bottom of a list of threads. All of the presently disclosed methods can be utilized to bump a thread down, as well as to bump a thread up.

Thus far, the discussion of a list of threads has generally concerned the order of threads naturally occurring in the forum. This natural order has been described as a function of the time of the latest posting in the threads. However many other orders are possible such as a function of the time each thread was started. It will be appreciated that a particular thread's position can be determined by posting activity in other threads in the forum. Thus, as used herein, reference to posting activity within a thread can inherently include posting activity within other threads.

It will be appreciated that many online discussion groups provide a search engine for searching the threads in the forum for threads containing particular key words or phrases, for example. When a user performs a search, the search engine returns a list of threads responsive to the search. This list may be organized as a function of the time of the latest posting in the threads. Alternatively, the listing could be organized by relevance, for example, with the threads containing the most occurrences of the searched terms or the most number of searched terms appearing higher on the list. According to the present disclosure, sponsored threads can trump these factors and appear at a favorable position in the list, regardless of their timeliness or relevance. Thus, as used herein, a “list of threads” can refer to either a general list of threads in a discussion group or to a list that is responsive to a search.

As will be appreciated by those of skill in the art, Internet users can interact with online discussion groups in a variety of ways. “Lurkers” can typically read posts within the various threads simply by clicking on the threads. Users, however, may be required to log into the particular forum to submit postings, responses, threads, etc. Logging in typically includes submitting a user name and password and may result in the user being provided with a user interface (UI) that allows the user to post to the discussion group.

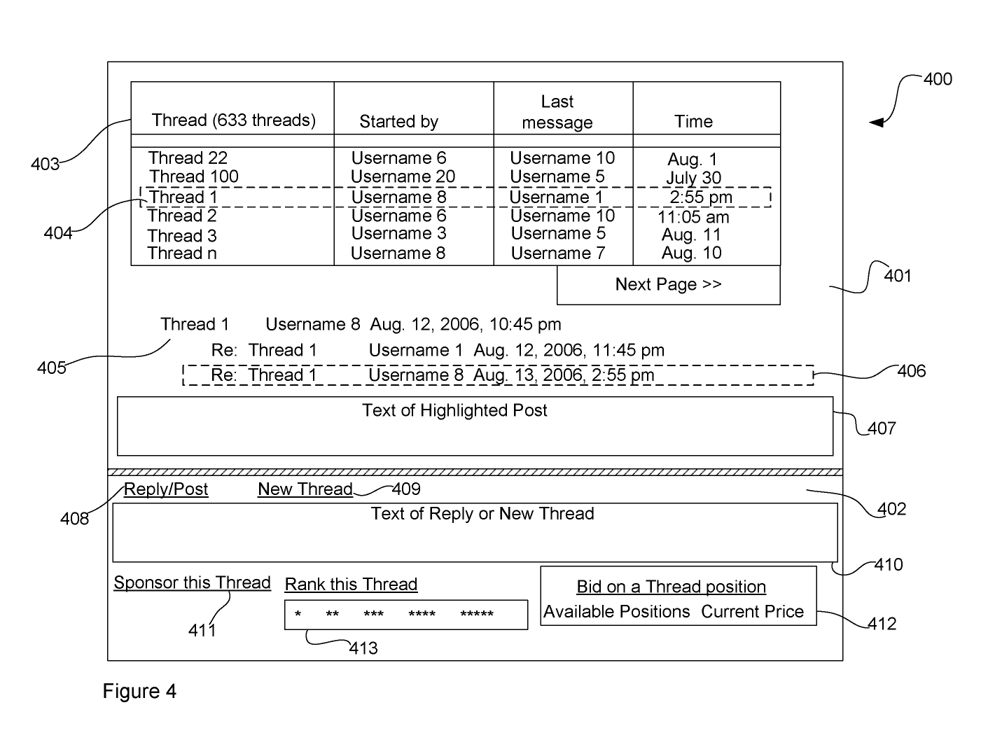

FIG. 4 illustrates an example UI for interacting with an online discussion group. UI 400 is divided into two fields; field 401 and field 402. Field 401 allows a user to navigate the threads in a discussion group and view the posts therein. Field 401 includes a list of threads 403, as illustrated in FIG. 3. By accessing (i.e. highlighting or clicking) a particular thread 404, a user can expand the hierarchical structure 405 of the thread to view the individual posts within the thread, as illustrated in FIG. 2B. By accessing a particular post 406, a user can display the text of the post. Field 401 might be available to a user without requiring the user to log into the discussion group.

An expanded UI including field 402 can be provided to users that log into the discussion group. Field 402 allows users to post replies 408 to existing threads and create new threads 409. Field 402 can include a text box 410 for typing a reply or post.

According to the present disclosure, field 402 allows users to sponsor threads, as described above. For example, a user can click link 411 to sponsor a thread. On clicking link 411 a user can be provided access to a webpage or dialog box where the user can enter into a monetary arrangement to sponsor a thread. Alternatively, the particulars of such monetary arrangement, i.e., pricing, payment information, rules, etc., can be agreed to when a user registers with the forum provider, such that a user need only click link 411 to sponsor a thread. Field 402 can also provide a user with an interface element 412 for bidding on sponsored positions in the list of threads. Interface element 412 can include a list of available positions and their price. Field 402 can also provide interface elements allowing a user to rank threads 413, send messages to the forum administrator (not shown), etc.

One of skill in the art will appreciate that the present disclosure provides methods of influencing the position of threads within an online discussion group. A user can use the disclosed method to influence the position of a thread, whether or not the user created or has posted in the thread. While in general, threads are posted as a function of their timeliness, an interested user can pay to offset timeliness. Within the present disclosure and claims, references to “moving,” as in “moving a sponsored thread”, “bumping up”, and “changing position” includes not only moving, but also copying. For example, if a thread is moved from a first position in a list to a second position, the thread might simply be copied to the new position and the occurrence in the first position can either be deleted or remain.

While the majority of the discussion has concerned changing the position of a thread pursuant to a monetary arrangement, the disclosure is intended to cover any method of affecting the likelihood that a thread will be accessed. For example, pursuant to a monetary arrangement, the noticeability of a thread can be manipulated by highlighting, bolding, changing the color, or otherwise accentuating the thread or portions of the thread.

Aspects of the present disclosure enable the use of a thread for advertising. A thread may start as an ad, or it may be used as an ad, but in essence it is a conversation, and it evolves and it is not controlled or owned by anyone. This means, for example, a bad promotional post can draw angry replies from users, which may cause the promoter to remove the sponsorship or even delete his post. The benefit is that the quality of an ad is constantly monitored and improved by users. False advertisement, for example, will be removed naturally. Also, users can inquire about products conveniently within the thread, and the provider can respond directly to such inquiries. This gives the provider a chance to defend his product, to provide more information when needed, and to share knowledge through online conversation.

Threads in an online discussion group are potentially a superior advertising media than the commonly seen banner ads or contextual ads, because a thread is a bi-directional conversation, as opposed to a one-directional broadcast. For example, native threads in an online discussion group are potentially more noticeable to forum users, which contribute to higher click-through rates, etc. Threads provide a two-way experience in that users can reply to ads by asking questions or sharing experience and advertisers can defend or discuss products and share knowledge. Ad quality is maintained because users can bury ads or advertisers that fail to meet a certain standard. Furthermore, threads allow an advertiser to maintain an appearance of being neutral, in that a thread is an organically developing medium that might not have arisen from the advertiser in the first place, the advertiser does not own, and the advertiser does not completely control.

While the description has focused on forums, the described techniques and methods are also relevant to mailing list archives and Usenet archives which have a user interface similar to forums. For example, the presently disclosed methods can be implemented via software configured to interact with Usenet or similar media. Additionally, the disclosed methods can be implemented in software designed to interact with forum-type content, for example, when such content is provided as XML, etc. According to such an embodiment, a provider of stand alone forum reader software can partner with a sponsored thread provider in an arrangement to share revenue generated by the methods described in this disclosure.

The disclosed method can be implemented in digital electronic circuitry, or in computer hardware, firmware, software, or in combinations of them. For example, the software implementations have been referred to generally as “forum software” but this term can include third party add-ins, etc and can also be implemented as hardware, firmware, etc., as mentioned above. It can also include a third party service that is implemented in software that is separate from the forum software but that the forum provider uses to add the features described herein to his forum. Apparatus of the disclosure can be implemented in a computer program product tangibly embodied in a machine-readable storage device for execution by a programmable processor; and method steps of the disclosure can be performed by a programmable processor executing a program of instructions to perform functions of the method by operating on input data and generating output. The method can be implemented advantageously in one or more computer programs that are executable on a programmable system including at least one programmable processor, coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the disclosed methods and apparatus have been described. Nevertheless, it will be understood that various modifications may be made without departing from the spirit and scope of the invention. Accordingly, other implementations are within the scope of the following claims.

We claim:

1. A method of affecting the likelihood that a particular thread in an online discussion group will be accessed, the method comprising:
displaying a list of threads;
receiving a request from a user to manipulate the noticeability of a selected thread within the list in exchange for a monetary arrangement; and
in response to the request, manipulating the noticeability of the selected thread.

2. The method of claim 1, wherein manipulating the noticeability comprises changing a position of the selected thread within the list of threads.

3. The method of claim 2, wherein the list is arranged according to posting activity within the threads and wherein the position of the selected thread is changed regardless of posting activity within the selected thread.

4. The method of claim 2, wherein displaying a list of threads comprises displaying a first group comprising a list of sponsored threads and displaying a second field comprising a list of non-sponsored threads.

5. The method of claim 4, wherein the non-sponsored threads are arranged with respect to posting activity within the threads and wherein the selected thread is moved from the second field to the first field regardless of posting activity within the selected thread.

6. The method of claim 2, wherein the list occupies more than one page of a display and wherein changing the position of the selected thread comprises moving the selected thread from a later page to a first page of the display.

7. The method of claim 2, wherein changing the position of the selected thread comprises moving the selected thread up the list.

8. The method of claim 2, further comprising arranging for the selected thread to remain in the changed position for a predetermined amount of time and wherein the monetary arrangement is based on the amount of time.

9. The method of claim 2, further comprising accepting bids for a favorable position from a plurality of users and awarding the favorable position to a user with a highest bid.

10. The method of claim 2, wherein a message contained in the selected thread comprises a hypertext link and wherein the payment corresponds to a given amount of money for each time the hypertext link is accessed.

11. The method of claim 2, wherein the payment corresponds to a number of times the thread is accessed.

12. The method of claim 2, further comprising:
responsive to a search of the list of threads; displaying a resulting list of threads; and
displaying the selected thread at a position within the resulting list of threads, wherein the position of the selected thread is determined by the monetary arrangement

13. The method of claim 1, wherein manipulating the noticeability comprises one or more of highlighting, bolding, and changing the color of at least a portion of the thread.

14. A forum server comprising:
a web server configured to interface with the Internet and provide web pages for viewing via the Internet;
forum software connected to the web server and configured to control a forum; and
a forum database connected to the forum software, the forum database comprising a plurality of threads; wherein the forum software is configured to:
construct a list of threads;
receive a request from a user to change a position of a selected thread in exchange for a monetary arrangement; and
in response to the request, change the position of the selected thread within the list.

15. The forum server of claim 14, wherein the forum software is further configured to provide a user with a user interface, the user interface comprising controls for choosing the selected thread.

16. The forum server of claim 15, wherein the user interface further comprises controls for executing payment for changing the position of the selected thread.

17. The forum server of claim 16, wherein executing payment comprises bidding.

18. A method of organizing a list of threads in an online discussion group, comprising:
receiving a posting to a first thread at a first time;
reordering the list of threads responsive to the posting to the first thread, the reordering including:
moving the first thread up a generally reverse chronologically ordered list of threads; and
determining if a second thread having a latest post at a second time, the second time earlier than the first time, is to remain higher on the list of threads as compared to the first thread based on a financial arrangement made with respect to the second thread and its location in the list of threads; and
providing the list of threads as reordered to a requestor of the list of threads.

19. The method of claim 18, wherein the financial arrangement made with respect to the second thread requires that the second thread remain in a preferred position in the list for a predetermined amount of time.

20. The method of claim 18, wherein the financial arrangement made with respect to the second thread requires that the second thread remain in a preferred position until the second thread has been accessed a predetermined number of times.

21. The method of claim 18, wherein the second thread comprises a hypertext linked and wherein the financial arrangement made with respect to the second thread requires that the second thread remain in a preferred position until the hypertext link is accessed a predetermined number of times.

22. A computer-readable storage media embodying instructions executable by a computer to perform a method of organizing a list of threads in an online discussion group, in accordance to financial arrangements made with respect to at least one of the threads within the list of threads.

23. The media of claim 22, wherein the method comprises
displaying the list of threads;
receiving a request from a user to change a position of a selected thread within the list in exchange for a monetary arrangement; and
in response to the request, changing the position of the selected thread within the list.

24. The media of claim 22, wherein the method comprises
receiving a posting to a first thread at a first time;
reordering the list of threads responsive to the posting to the first thread, reordering including:
moving the first thread to the top of a generally reverse chronologically ordered list of threads; and
determining if a second thread having a latest post at a second time, the second time earlier than the first time, is to remain higher on the list of threads as compared to the first thread based on a financial arrangement made with respect to the second thread and its location in the list of threads; and
providing the list of threads as reordered to a requestor of the list of threads.
